(19) United States
(12) Patent Application Publication
(10) Pub. No.: US 2008/0137712 A1
(43) Pub. Date: Jun. 12, 2008

(54) Insulating Improvement Of Cables With Sensors

(76) Inventors: Ivanir Antonio Gobbi, Canoa, RS (BR); Flavio Paulo Perguer, Porto Alegre RS (BR)

Correspondence Address: OSTROLENK FABER GERB & SOFFEN, 1180 AVENUE OF THE AMERICAS, NEW YORK, NY, 100368403, US

(21) Appl. No.: 11/573,150

(22) PCT Filed: Jul. 14, 2005
(86) PCT No.: PCT/BR05/00131

§ 371 Date: Feb. 2, 2007

(30) Foreign Application Priority Data
Aug. 3, 2004 (BR) MU 8401979-4

(51) Int. Cl. G01K 1/08

(52) U.S. Cl. 374/208; 374/E01.011

(57) ABSTRACT

The present invention refers to an innovative construction introduced in an insulating system at the end of cables with electric-electronic sensors. The insulating system has a rubber plug that covers the end of the insulating cap of the sensor's supply cable. A metal cap is partially filled with epoxy resin (that covers the sensor in such a way that it sticks to the end of the rubber plug. The end of the cap is deformed to make a peripheral indentation against the rubber plug. The shape of the rubber plug has a proximal end of a diameter that is compatible with the internal diameter of the metal cap and a distal end of a larger diameter to create a support lift for the cap during the assembly. An optional construction for the rubber plug is a continuously cylindrical shape.

### CROSS REFERENCE TO RELATED APPLICATION

The present application is a 35 U.S.C. § 371 national phase conversion of PCT/BR2005/000131 filed Jul. 14, 2005 which claims priority of Brazilian Patent Application No. MU 8401979-4 filed Aug. 3, 2004, which are incorporated by reference. The PCT International Application was published in the English language.

The present invention refers to an innovative construction introduced in an insulating system at the end of cables with electric-electronic sensors.

The end of the sensor supply cables must be insulated, mainly against humidity to avoid measuring mistakes. For example, the cables commonly used to determine a physical characteristic have temperature sensors in refrigeration equipment. Those cables work as probes and are immersed in the material mass to be measured. As electronic components are used at the end of the cable, such as a plate with a thermistor for example, the end must be waterproof enough to stop any damp penetration. If not, damp is likely to change the reading of the physical characteristic and result in an inaccurate value.

The usual protection technique of those sensors uses a metal cap that is filled with thermoretractile resin, in which the cable end with sensors is immersed. It sensor is previously protected with resin, generally epoxy resin. Once the thermoretractile resin inside the metal cap is dry it sticks perfectly to the cable and thereby protects the sensor inside.

Nevertheless, even this insulating technique encounters the following failures:
the sensor is not entirely covered with thermoretractile resin when gaps are left inside the cap, thereby exposing the sensor to direct contact with the metal wall and damp, and resulting in inaccurate readings;
the use of poor quality resin results in air bubbles and water build-up through infiltration, and thereby also results in inaccurate readings.

Therefore, the object of this invention is to present an innovative construction in the insulating system at the end of cables equipped with electric-electronic sensors. The plug of the system proposed made of elastomer, preferably silicon rubber, covers the end of the insulating cap of the sensor supply cable. A metal cap partially filled with epoxy resin covers the sensor and sticks to the end of the rubber plug. Finally, the end of the cap is deformed so as to obtain a peripheral indentation around the rubber plug. The cap necking effectively stops the sensor from any contact with damp.

The improvement in the insulating system used for sensor cables in question in this invention has the following advantages on the more conventional techniques:
more effective damp proofing
better finish
no thermoretractile resin required

For a better understanding of the insulating system for electric sensor cables of this invention, the following detailed description is provided, based on the drawings supplied in appendix:

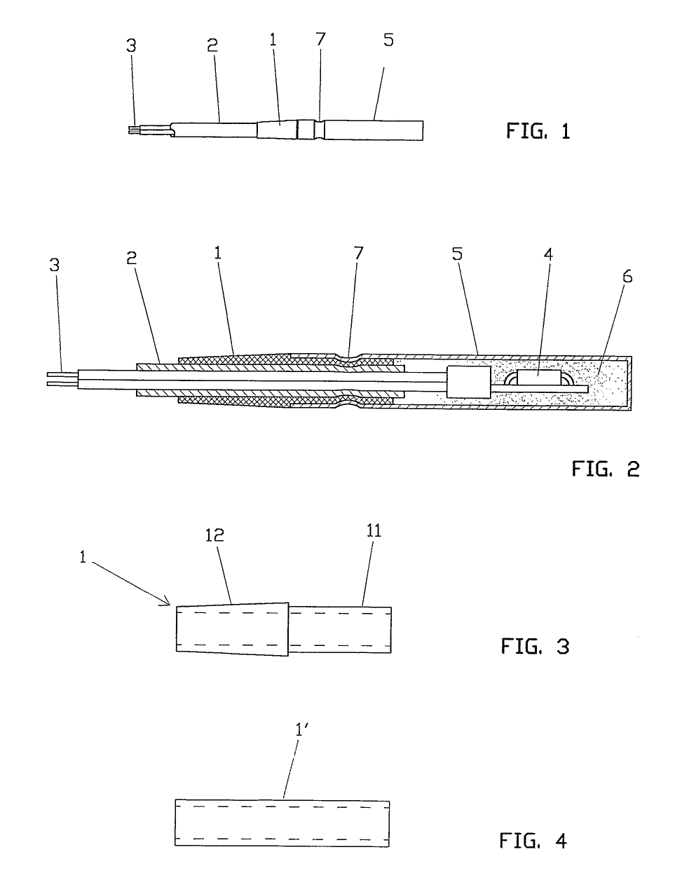

FIG. 1—side view of the cable end with an insulated sensor;

FIG. 2—sectional view of the insulated cable end;

FIG. 3—detail of the rubber plug shape;

FIG. 4—detail of one construction option for the rubber plug.

FIGS. 1 and 2 illustrate the insulating system proposed, including one rubber plug (1) to cover the insulating cap end (2) of the sensor's (4) supply cable (3). A metal cap (5) is partially filled with epoxy resin (6) and placed on top of the sensor (4) so as to cover the end of the rubber plug (1) too. The cap end (5) is deformed, thereby making a peripheral indentation (7) against the rubber plug (1).

FIG. 3 specifies the shape of the rubber plug (1) whose proximal end (11) has a diameter compatible with the internal diameter of the metal cap (5) and a distal end (12) of a larger diameter so as to create a support lift (5) during the assembly.

FIG. 4 specifies a construction option for the rubber plug (1), which then has a continuously cylindrical shape.

1. “INSULATING IMPROVEMENT OF CABLES WITH SENSORS” using a metal cap, which covers the end of the sensor's supply cable, wherein having a rubber plug that covers the end of the insulating cap of the sensor's supply cable, which comes on top of the end of the metal cap which is partially filled with epoxy resin, thereby leaving the sensor protected away inside the cap, whose end has been deformed to make a peripheral indentation against the rubber plug, whereby the rubber plug has a proximal end of a diameter that is compatible with the internal diameter of the metal cap and a distal end of a larger diameter, working as a support lift for the cap.

2. “INSULATING IMPROVEMENT OF CABLES WITH SENSORS” according to claim 1, wherein having a rubber plug optionally of a continuously cylindrical shape.
